(19) United States
(12) Patent Application Publication
(10) Pub. No.: US 2018/0093343 A1
(43) Pub. Date: Apr. 5, 2018

(54) WELDING TORCH AND SUBMERGED ARC WELDING PROCESS TECHNIQUE IN ONE SINGLE PASS FOR EACH LAYER AND AT LIMITED VOLUMES OF WELDING WITH HIGH WALLS

(71) Applicant: BELLELI ENERGY CPE S.r.l., Mantova (IT)

(72) Inventors: Stefano Alberini, Mantova (IT); Alessandro Fantin, Mantova (IT); Fausto Fusari, Mantova (IT); Michele Musti, Mantova (IT); Paolo Fedeli, Mantova (IT)

(21) Appl. No.: 15/717,228

(22) Filed: Sep. 27, 2017

(30) Foreign Application Priority Data
Sep. 30, 2016 (IT) 102016000098492

(51) Int. Cl. B23K 9/18; B23K 9/28; B23K 25/00; B23K 37/04

(52) U.S. Cl. CPC B23K 9/186; B23K 37/04; B23K 25/00; B23K 9/287

(57) ABSTRACT

Submerged arc welding torch adapted to perform welding in one single pass for each layer on high walls, of the type constituted by a support body from which two wire-guiding lances, held in reciprocal engagement by screws and pins, depart, each of said lances provided with an internal cavity for the insertion of the welding wire, at the end of which a welding material delivery nozzle is provided, characterized by the fact that further departing from said support body are a feeler lance support and a centrally arranged flow delivery duct, said wire-guiding cavities being incorporated into a pair of lances.

This application claims priority from Italian Patent Application No. 102016000098492 filed Sep. 30, 2016. The content of this application is incorporated herein by reference in its entity.

### DESCRIPTION

### Field of the Invention

The present invention relates to a welding torch and a welding technique for the submerged arc process in one single pass for each layer with high thickness and limited volumes of welding.

### Background of the Invention

The construction of a high-pressure and high-temperature equipment envisages the use of highly resistant materials and the welding of very thick walls that need the welded joint to be designed so as to be able to limit the volumes of welding in order to obtain a better quality (shrinkages, deformations, stress, etc. . . . ) and to contain the relevant costs.

As a rule, a preparation with a narrow welded joint is used, known as Narrow Gap (NG), which allows to define almost parallel walls with an opening of 23-25 mm.

Such a preparation, which is especially used for the submerged arc welding process, envisages a sequence of depositing the welding material in two passes for each deposited layer. However, this procedure, performed with a conventional torch, has proved to be not fully effective because qualitative differences along the welded surface are recognized, in particular between the centre of the welding and the central portion of the pass at the sides of the joint.

As a matter of fact, overlapping areas of the passes can be observed, with a reduction of the mechanical performance of the welded component and/or, in any case, their unevenness.

Lately, an international research related to the use of low-alloy high-resistance chromium-molybdenum-vanadium material (2.25 Cr-1M0-0.25 V), generally intended to be used for the design of reactor equipment of refining plants, operating at high temperatures, has showed that the results of the creep tests may be lower than the limits set by the design codes, thus high-lighting that the mechanical properties are inadequate compared to technical requests due to a particular central area between the two passes that is weaker than the rest of the joint.

It is therefore appropriate to perform a welding process that is capable of reducing the amount of material deposited on the surface to be welded and, at the same time, to ensure the correct position of the welding passes, in such a way as to make the metallurgical aspect of the welding itself more uniform and qualitatively better. In order to solve this problem, it is needed to provide for a welding torch which is capable of depositing the welding material especially for very high and narrow walls so as to ensure the deposition in the correct manner and by means of a single layer.

Therefore the invention has developed a welding technology characterized by a “one pass for each layer” sequence that could eliminate this critical area.

Such “one pass for each layer” welding technology, thus with a narrow gap, called BMT (BELLELI MONOWELD TECHNOLOGY) might also be able to reduce the amount of material deposited on the surface to be welded and at the same time to ensure the proper positioning of the welding passes so as to make the welding itself more even and improve its mechanical properties.

Therefore, this invention aims to provide a welding torch and a welding process that meet the above-mentioned requirements.

Such an object is achieved by means of a welding torch having the features disclosed in claim 1) and a welding process as in claim 11).

The secondary claims relate to specific preferred features of the invention.

### BRIEF DESCRIPTION OF THE FIGURES

The invention is now described with reference to the accompanying drawings, apt to represent in a merely illustrative and not limiting way a preferred embodiment, wherein:

FIG. 1 is a partially sectional view of a welding torch of the prior art;

FIG. 2 is a perspective view of a welding torch according to the invention, of which

FIG. 3 is the front view

FIG. 4 is the side sectional view

FIG. 5 is the detailed view of the portion of the nozzles of the torch according to the invention,

FIG. 6 is a sectional view of the mechanical guide provided on the torch according to the present invention;

FIG. 7 is the side view of a scorifier according to the invention,

FIG. 8 is the view of the detail of the scorifier operating during the welding process associated to the torch according to the invention;

FIG. 9 is a view of the welding system on which the torch according to the invention and the scorifier are installed,

FIG. 10 is a graph that illustrates the results of the hot break tests due to creep of a NG process with two passes for each layer and the NG process according to the invention, respectively; and

FIG. 11 is a graph that shows the transition curve of the process according to the invention.

### DETAILED DESCRIPTION OF THE EMBODIMENTS

The submerged arc welding process is an arc welding process which melts together the parts to be welded by heating them with one or more electric arcs between one or more bare electrodes and the item, by constantly energizing the electrode. The heat of the arc melts the surface of the base metal and the end of the electrode, thus ensuring that a layer of deposited metal made of the alloy of the two compounds is created.

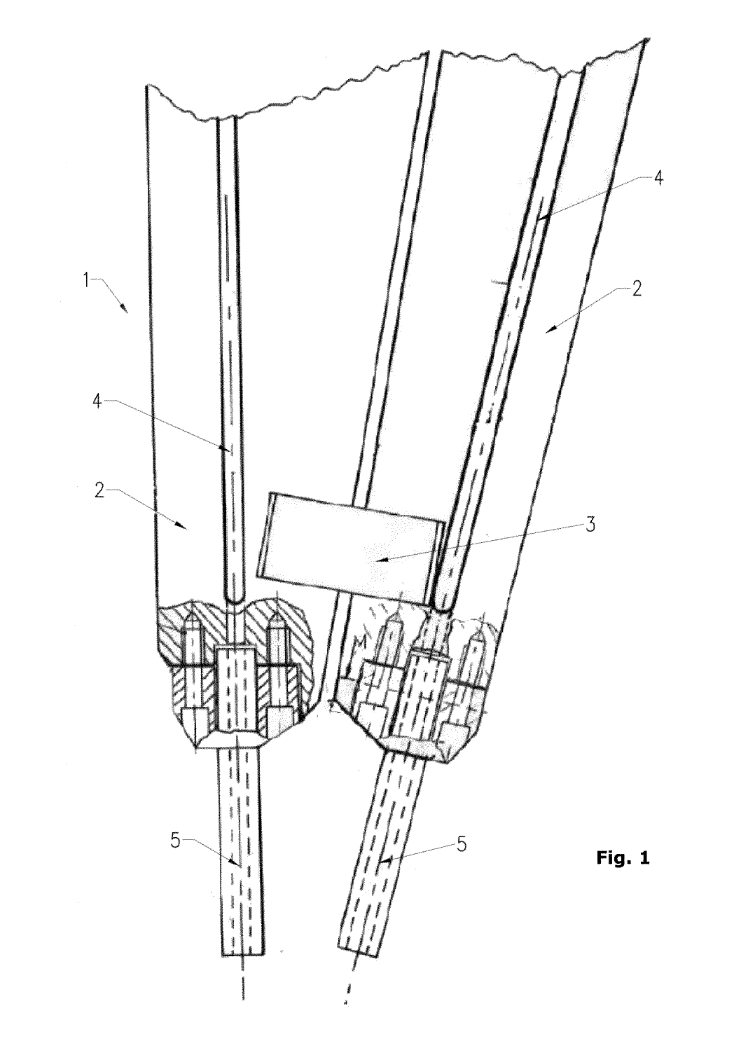

As shown in FIG. 1, the welding torch is typically constituted by a support body 1 which is composed of two wire-guiding lances 2 mutually engaged by a fixing plate 3, each of said lances provided with an internal cavity 4 for the insertion of the welding wire, at the end of which a nozzle 5 for releasing the welding material is provided.

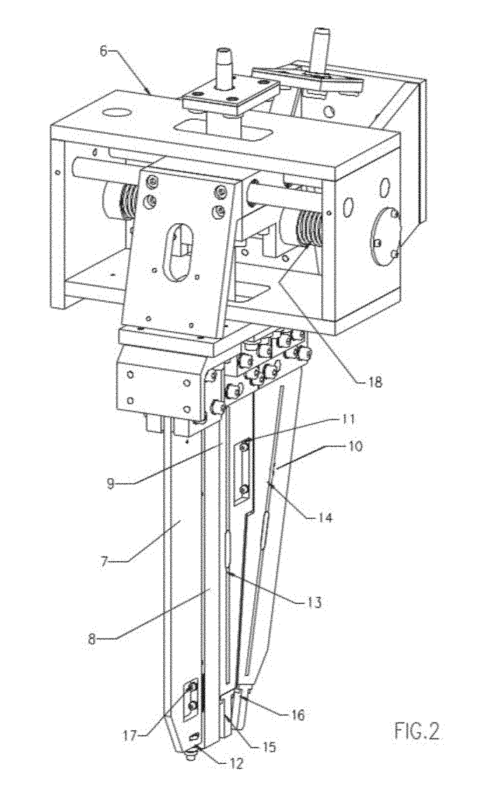

In the innovative solution, illustrated in FIG. 2, the torch according to the invention is constituted by a support 6, from which the following elements depart: a feeler lance support 7, a centrally positioned flow delivery duct 8, and a pair of lances 9 and 10, which are connected between them by means of screws 11, to form a substantially trapezoidal profile.

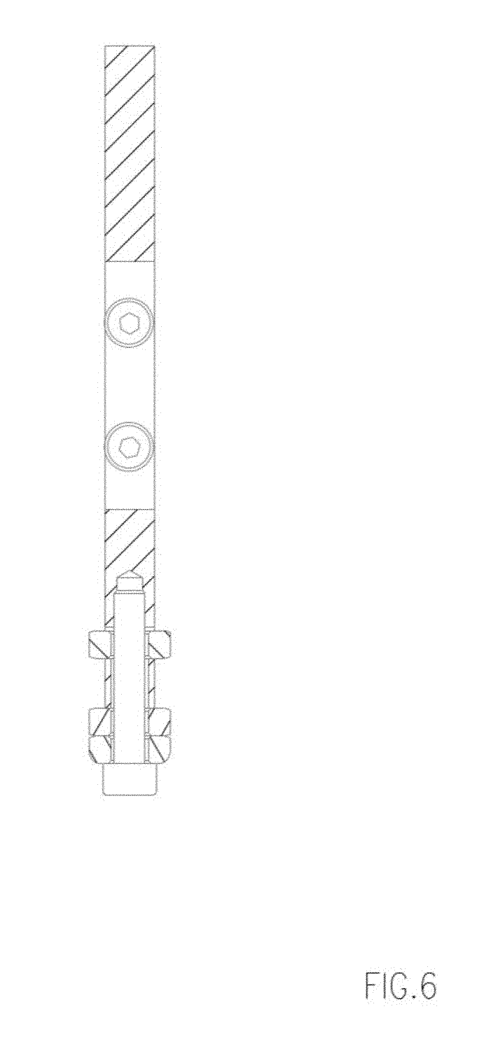

Said feeler lance support 7 incorporates a mechanical guide 12, which is better shown in section in FIG. 6, positioned at the distal end to allow the constant and correct alignment of the nozzles with respect to the welding area.

Said lances 9, 10 support on their inside wire-guiding cavities 13 and 14 aimed at transporting and delivering the welding wire, the end of the aforesaid lances 9 and 10 being provided with nozzles 15 and 16 for the supply of the welding material.

What is also provided is a screw and pin connection element 17 to keep the connection of the feeler lance 7 to the flow delivery duct 8.

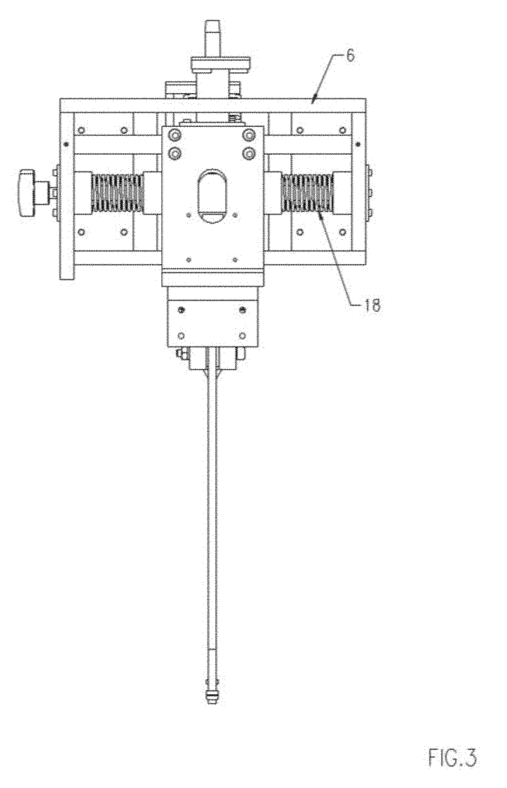

The support structure 6, provided with spring means 18, can be seen in FIG. 3 in order to allow the tilting of the torch during operation.

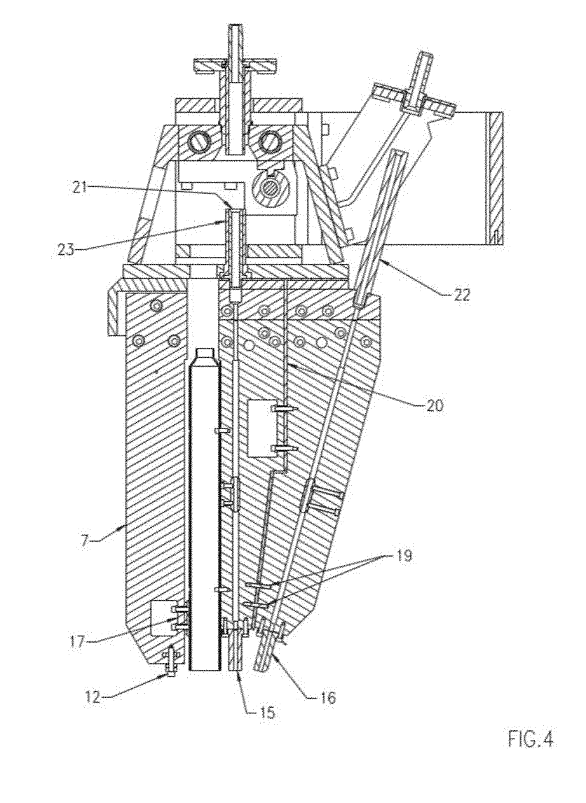

FIG. 4, in addition to the previously described and here differently represented elements, illustrates further connection means 19 between the two lances 9 and 10, said connection being constituted by two alignment pins. In addition, along the line of demarcation between the two lances 9, 10, a strip of insulating material 20 is provided, which covers the entire border area.

At the top of the wire-guiding lances 9 and 10, wire-guiding tubes 21, 22 are provided, possibly covered by isolation bushings 23 for protection. Likewise, isolation bushings for protection are provided in various parts of the torch, to reduce the risk of excessive heat dispersion and accidents caused by this condition.

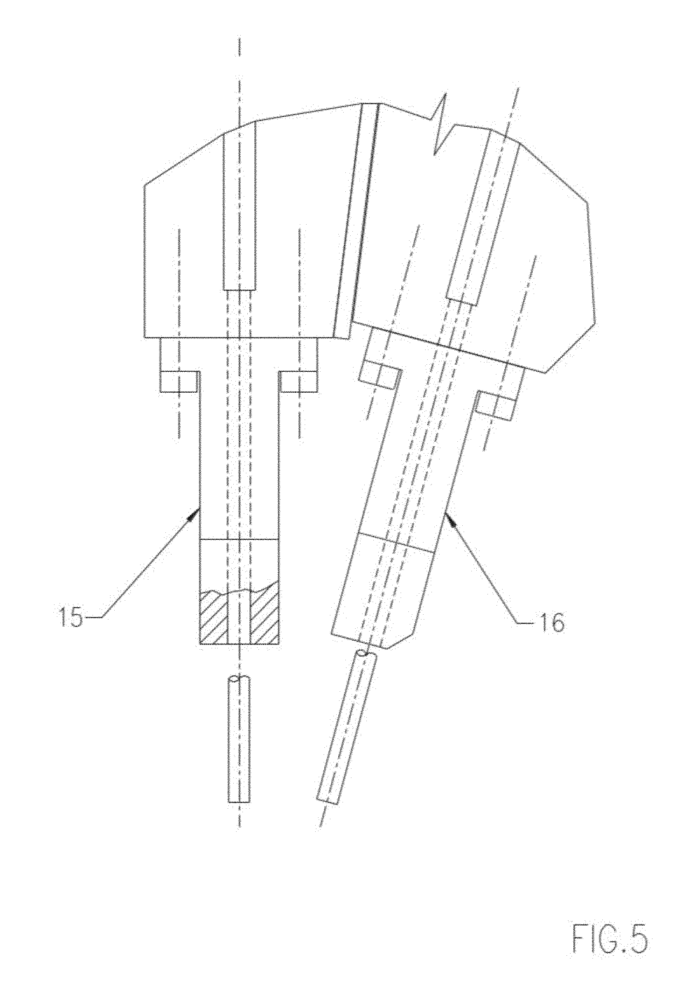

The particular specificity of this torch lies in the size—length and thickness—of the nozzles 16 and 17, as can be seen in FIG. 5, which were especially modified, if compared to those used in common practice, to obtain a lower thickness and a greater length and adapted to better ensure the discharge of the gases generated by the melting bath, given the very reduced width of the joint.

These peculiarities are fundamental and essential in order to be able to perform a welding of the required quality on high walls and by adopting a preparation for a welding process of one pass for each layer.

By means of the mechanical guide 12, whose section is shown in FIG. 6, the welding torch is able to keep a constant position at the centre of the joint especially by ensuring the constant distance of the torch itself, and the welding wire, with respect to the wall to be welded, irrespective of the movement of the workpiece to be welded.

The mechanical guide 12 is connected to a translation system transverse to the joint provided with preloaded springs 18, whose suitably determined size causes the guide itself to keep the defined position at the centre of the joint by absorbing the possible movement, always in the transverse direction, of the workpiece to be welded.

The torch thus realized is associated to a tool 24 for removal of slag from the welding area, closely connected in a real system to said torch and to a device for the movement of the item to be welded.

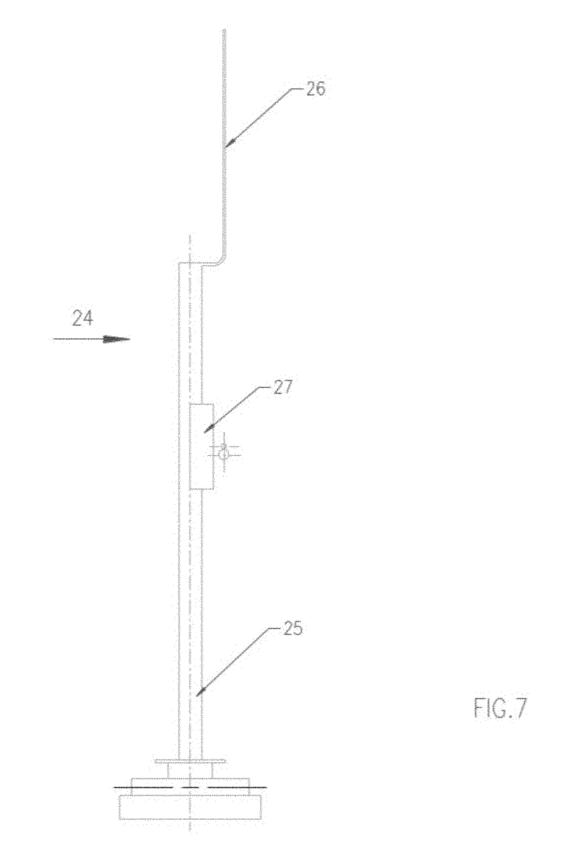

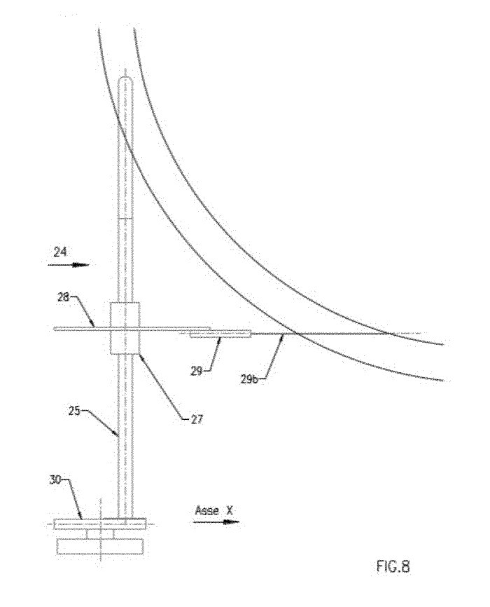

The tool 24 for removal of slag from the welding area, shown in FIGS. 7 and 8, is composed of a rod 25, which carries a bayonet 26 at its top for centering the gap, and a linear guide 27, whose height can be adjusted, that provides a through hole—perpendicular to the rod 25—where a further linear guide 28 is housed and carries a pneumatic hammer 29 at its end, from which—in turn—a stem 29b protrudes and directly engages to the welding and slag cleaning area.

The structure thus realized is mounted on a passive linear guide 30, provided with springs, which allows the structure to maintain the substantial stability along the axis X.

The tool thus realized is correctly positioned during the welding step, as will be described later.

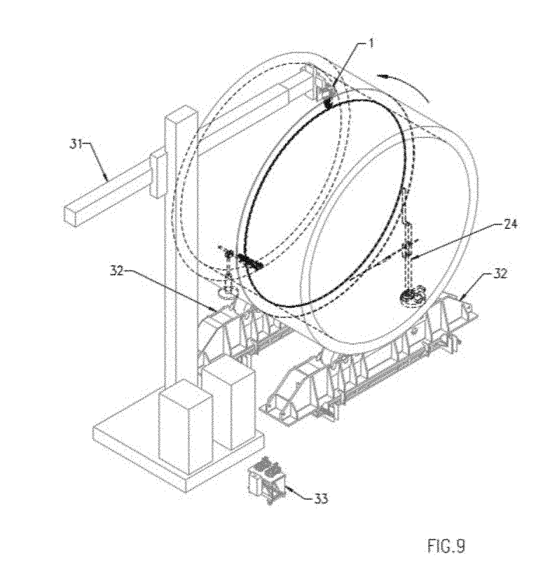

As can be seen from FIG. 9, the system is composed by the torch kept suspended by means of a rod 31, so that the welding is performed close to the point of maximum height of the shell, and thus positioning one single layer of welding material, by two rollers 32, which cause the body to be welded to rotate, and by the tool 24 in close connection with the two above mentioned elements.

The plant herein described is controlled by a control panel 33 provided at a distance with respect to the main structure for safety and convenience reasons, suitable to ensure the proper management of each element characterizing it.

As it can be understood, during operation, it is necessary that the operator positions the bayonet 26 for centering the gap so as to act as a guide on the shell and cause it—during rotation—to keep the correct position with respect to the torch. At the same time the pneumatic hammer cleans the welding area from the slag material, in such a way as to guarantee a suitable welding for the next welding pass/layer.

In turn, the position of the mechanical guide and its size, especially designed for this purpose, causes the welding torch to be able to keep constant the distance of the wire lance, defined during the development of this technology, and therefore the distance of the welding wire with respect to the wall to be welded. The rotation of the shell occurs by means of the two rollers operated by a control panel.

The arc welding process associated to such torch envisages the following steps for it to provide the required performance, even if the welding joint is narrower:
Selecting suitable welding materials
Calibrating the specific welding parameters suitable to obtain both the required physical-chemical properties and related metallurgy, and the shape of the welding passes suitable for a good slagging and free from defects in a significantly limited space.
Defining the correct width of the welding joint before starting welding on the basis of the effects of the deformation of the surface at the end of the operation, in order to keep in any case the desired distance between the edges and, as a consequence, the correct performance of one single pass of the torch, until the welding is completed.
Using the presently described torch during the welding process, which is part

of this invention.

It is also appropriate, in order to obtain an effective welding, that the welding joint has a very limited width, comprised between 10 and 17 mm, and more preferably between 14 and 15 mm, in such a way as to allow a significant reduction of welding times and a total qualitative uniformity as far as thickness and transverse directions are concerned.

The reduced width of the joint makes it difficult to remove the slag produced during welding. For this reason, a slag removal system has been designed by means of the tool 24 intended for removing slag from the welding area.

The slag is moved forward and, before a second pass/layer, the area to be welded undergoes a treatment by the pneumatic chisel (or hammer), positioned to pass along the welding area and take the slag off the bead, in such a way that the welding surface is clean upon engagement with the torch.
The execution of welding in one single pass for each layer requires greater control of the rotating workpiece with respect to the welding torch for circular welds. In fact, the rotation of the pieces to be joined involves axial displacements (drift) which must necessarily be counterbalanced by a suitable hydraulic/mechanical anti-drifting system.
The overall scheme required for the execution of welding of one pass per layer, in particular for circular joints, is shown in FIG. 9.

### EXAMPLE

By way of example, an example of the operation of the torch and the process according to the invention is given.

It was decided to weld two pieces of low-alloy, high strength mechanical material having the following nominal chemical composition: 2.25 Chromium, 1 Molybdenum, 0.25 Vanadium.

Suitably, the welding joint has a width of 14 to 15 mm.

Once the torch has been set up, an alternate current arc welding with square wave is performed by supplying specific electric parameters for each wire, which has been appropriately chosen with a diameter of 4 mm:

Current intensity: 500-600 Amp

Voltage: 30-33 Volt

The other parameters relating to pre-heating, heat treatment, post-heating are the typical ones applicable to this type of base material and comply with API RP 934 A standard.

In addition, the advancement speed of the torch has been adjusted at 70-80 cm/1′. The obtained results show that the non-destructive tests and the mechanical features performed on the welded joint meet the requirements of the manufacturing standards. In particular, a significant reduction in welding times was immediately observed.

All non-destructive controls such as magnetoscopic and ultrasound examination were performed, with positive results based on the quality criteria required by the ASME code and the API RP 934 A standard.

A series of test specimens for mechanical characterization were then obtained, with a general improvement in welding quality.

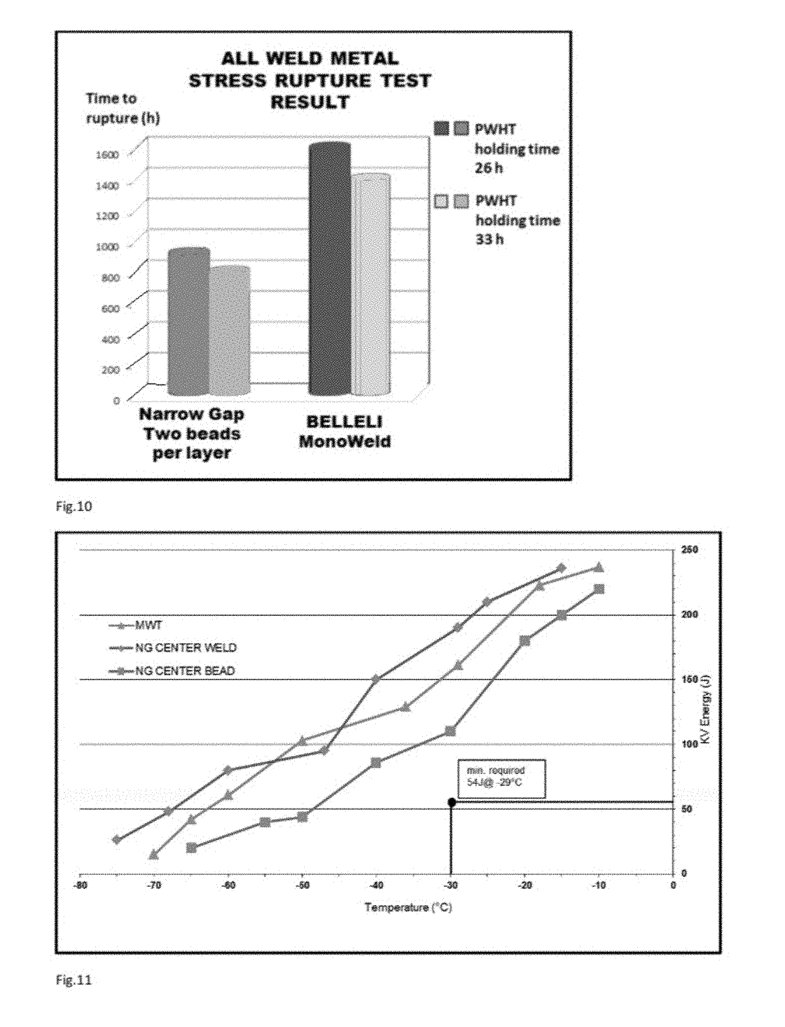

Specifically, the tests performed for high temperature creep resistance (Stress Rupture Tests) showed a significant improvement over the two-pass per layer technique, which was far superior to the limits required by the design code (see FIG. 10).

It is also to be pointed out that the toughness, which in itself presents considerable difficulties for the material in question, has yielded results far beyond the required limits by tests carried out at different depths of the performed joint and, above all, does not exhibit the typical unevenness found in the welding with two-pass technique between the welding centre and the pass centre (see FIG. 11).

In fact, the joint with reduced width (14-15 mm) allows a total qualitative uniformity in both thickness and transversal directions.

Lastly, the reduction in the number of passes and the relative number of heatings leads to a greater containment of welding retractions, deformations and residual stresses after welding.

It is therefore understood that the foreseen objectives are perfectly achieved.

Other features and properties of the invention may be apparent in the eyes of a field expert. In addition, different modifications and configurations can easily be within the reach of an experienced designer technician, while fully falling within the scope of the invention, as defined by the attached claims.

1) Submerged arc welding torch of the type constituted by a support body from which two wire-guiding lances, held in reciprocal engagement by screws and pins, depart, each of said lances provided with an internal cavity for the insertion of the welding wire, at the end of which a welding material delivery nozzle is provided, characterized by the fact that further departing from said support body are a feeler lance support and a centrally arranged flow delivery duct, said wire-guiding cavities being incorporated into a pair of lances.

2) Welding torch as in claim 1 characterized in that said feeler lance incorporates a mechanical guide, placed at the distal end, adapted to allow the constant and correct alignment of the nozzles with respect to the welding area.

3) Welding torch as in claim 1 characterized in that also provided is a screw and pin connection element, adapted to maintain the feeler lance in connection with the flow delivery duct.

4) Welding torch as in claim 1 characterized in that said support body is provided with spring means for adjusting the oscillations of said torch with respect to the body to be welded.

5) Welding torch as in claim 1 characterized in that two alignment pins are further provided between the two lances.

6) Welding torch as in claim 1 characterized in that an insulating strip is provided along the line of demarcation between the two lances.

7) Welding torch as in claim 1 characterized in that said nozzles are of lesser thickness and longer than those in use in common practice.

8) Welding torch as in claim 2 characterized in that said mechanical guide is connected to a translation system transverse to the joint, provided with preloaded springs, which is capable of maintaining the perfect centering of the coupling.

9) Welding system carrying the welding torch according to claim 1 of the type comprised of said torch held suspended by means of an upper rod and a roller conveyor capable of rotating the body to be welded, characterized in that a slag removal tool is further provided in the welding area.

10) Slag removal tool from the welding area for the welding system of claim 9, characterized in that it comprises a rod, which carries on its summit a centering bayonet of the gap, and an adjustable linear height guide which provides a through hole, perpendicular to said rod, for housing a rod bearing at its end a pneumatic hammer for removing the slag material.

11) Submerged arc welding process in one single pass for each layer associated with the welding torch and the welding system of claim 9, characterized in that the following steps are provided:
Selection of welding materials;
Calibration of welding parameters suitable to obtain both the physical-chemical and metallurgical properties and to obtain the shape of the welding passes suitable for a good slagging and free from defects in a significantly limited space;
Definition of the correct width of the welding joint before beginning welding on the basis of the surface deformation effects at the end of the operation; and
Use of the torch and the welding system.
